(19) United States
(12) Patent Application Publication
(10) Pub. No.: US 2003/0103209 A1
(43) Pub. Date: Jun. 5, 2003

(54) Imaging FTIR spectrometer

(75) Inventor: Arno Simon, Karlsruhe (DE)

Correspondence Address: Kohler Schmid + Partner, Ruppmannstr. 27, Stuttgart, D-70565, DE

(73) Assignee: Bruker Optik GmbH, Ettlingen (DE)

(21) Appl. No.: 10/302,908

(22) Filed: Nov. 25, 2002

(30) Foreign Application Priority Data
Dec. 5, 2001 (DE) 101 59 722.3

(51) Int. Cl. G01B 9/02

(52) U.S. Cl. 356/456

(57) ABSTRACT

The present invention relates to an imaging FTIR spectrometer comprising a housing with an integrated interferometer, sample and detector. The light of the source first passes through the interferometer, then it is focused on the sample which is imaged on the surface of a detector array. The present invention also provides an FTIR spectrometer with a detector array and ADCs integrated on the detector array chip such that each pixel has an individual dedicated ADC.

This application claims Paris Convention priority of DE 101 59 722.3 filed Dec. 5, 2001 the complete disclosure of which is hereby incorporated by reference.

### BACKGROUND OF THE INVENTION

The invention relates to an infrared spectrometer comprising an optical light source, a housing with an integrated interferometer to divide the input light beam emitted by the source into two partial beams and to generate a variable optical retardation between the two partial beams as well as to recombine these beams to one output light beam. Furthermore, the infrared spectrometer includes a sample position located within or at the housing to accept a sample at which the sample is either irradiated or transmitted by the output light beam, and an optical detector to analyze the detector light beam signal emitted by the sample, as well as means to process the sample signal available at the detector output.

Corresponding infrared spectrometers (FTIR spectrometers) are manufactured and distributed by the applicant, e.g. the IFS 66/S spectrometer described in applicant's “IFS 66/S” brochure, dated December 1999.

The prior-art FTIR spectrometers are used to measure infrared spectra either in transmission or reflection. They can have both, a compact and modular design, i.e. components can be easily replaced, if required, or the user can easily switch between components, e.g. between several sources or detectors, filters etc. A further outstanding advantage of these spectrometers is that they can be used in connection with external sources or detectors by means of inputs and outputs. They can measure spectra of sunlight, or by means of fiber optics or conventional optics they can be connected to an infrared microscope. The IR light generated within the spectrometer first passes the interferometer, is then directed to an outlet and finally reaches an IR microscope where it illuminates a sample. The light transmitted from or reflected by this sample then reaches an external detector. This detector can be an imaging detector array, e.g. an FPA array. Its output signals will be digitized, cached and processed by a PC to generate a two-dimensional spatially resolved spectrum.

At the Pittsburgh Convention in 2001, paper 839 of section 112 presented an infrared remote-sensing system where the light leaving a remote, external, extended object is transferred to an FPA detector by means of an interferometer, generating a spatially resolved spectrum of this object.

According to chapter 4 “New Designs” of lecture No. 2001 (A. Adams and M. Goodnough) at the Pittsburgh Convention 2000 it is known that analogue-to-digital converters (ADCs) can directly be mounted on an FPA detector chip, thus reducing operating costs and simplifying the system complexity. In the future, this may result in extremely high frame rates of >30 kHz for a 128×128 array. Therefore, this type of detectors is suitable for precise imaging remote-sensing systems incorporating pulsed lasers.

In FTIR spectroscopy an optical signal is frequency-modulated by the interferometer. This frequency-modulated signal is digitized and resolved into its spectral components by means of Fourier transformation and displayed. The known scanning theorem specifies the scanning rate to be at least twice the electrical bandwidth of the signal to be scanned. Thus, before digitizing the optical signal is usually limited by optical filters, and/or the bandwidth of the analogue signal by electrical components. Usual electrical bandwidths are a few kilohertz for speeds of the interferometer mirror in the range of mm or cm per second and spectral bandwidths of 15,800 cm⁻¹.

Usually, imaging IR spectroscopy uses FPA detectors consisting of 64×64 or more pixels. These pixels undergo a short-time exposure, and each pixel will be connected by means of an analogue switch to a digitizing unit (ADC) and digitized. This kind of scanning and conversion of a frame with e.g. 64×64 pixels corresponds to one interferogram data point generated by conventional (non-imaging) FTIR spectroscopy. Now, to be able to measure data with identical methods, the electrical bandwidth of the analogue and digital signal needs to be multiplied by the number of pixels. This means that the electrical bandwidth is a multiple of what is appropriate for a correct data acquisition. According to a cursory calculation the signal-to-noise ratio will in this way deteriorate by the square root of the enlarged bandwidth, i.e. in the above case by the factor 64.

On the one hand, the types of infrared spectrometers described above enable external objects to be irradiated by the output light beam of their interferometer and then to perform imaging spectroscopy by means of an external imaging detector. On the other hand, samples (non-imaging) inserted into the spectrometer sample compartment can be spectroscopically analyzed. There is demand for an even more versatile infrared spectrometer.

### SUMMARY OF THE INVENTION

The problem is solved in that the detector is an imaging, two-dimensional detector array being positioned in such a way and the detector light beam emanating from the sample within the infrared spectrometer compartment is focused on the detector array by means of imaging optics such that, an image of the sample surface is formed on this array.

In case of conventional FTIR spectrometers with integrated sample and detector compartments the optical system is designed such that the interferometer output light beam is optimally focused on the sample at the sample position, and that the light beam emanating from the sample is concentrated on the detector element of typically 1×1 mm. As the main focus is on the signal flow and the imaging characteristics of the detector optics are disregarded, it is not possible to simply replace the detector of a conventional FTIR spectrometer with an FPA array. Consequently, in prior art FTIR spectrometers having an imaging FPA detector, the light source, the sample compartment and the detector, i.e. the complete imaging optical path, were located outside the spectrometer housing. In accordance with the invention, the optical paths and optical features are re-designed to image a sample position inside the housing.

In one embodiment a conventional detector may subsequently be replaced by an imaging detector array.

In a preferred embodiment the detector light beam inside the housing can be switched between a conventional, non-imaging and an imaging detector array e.g. by means of a hinged mirror.

In an alternative embodiment according to the invention that may also be used on its own, the detector array and digitizing unit are designed such that the signal of a group of pixels or of each pixel of the array is subjected to a separate sampling procedure, yielding a minimum electrical bandwidth of each signal path. Preferably, each pixel has a dedicated bandwidth-limited signal path and digitization.

Especially, it is preferred to integrate the digitizing unit into the detector array, such that each pixel has its own ADC on the array chip. This solution is particularly compact, energy-saving, provides short analogue signal distances and offers best possibilities to adapt the electrical signal bandwidth to the data acquisition system.

Further advantages of the invention ensue from the description and drawing. Furthermore, according to this invention the features mentioned hereinbefore and described hereinafter each can be applied on their own or in arbitrary combinations. The embodiments illustrated and described are not to be considered as a complete list, but exemplify the invention.

The drawing illustrates the invention which is explained in detail in accordance with the embodiments.

### BRIEF DESCRIPTION OF THE DRAWING

FIG. 1 shows a schematic view of a prior-art infrared spectrometer;

FIG. 2 shows a schematic view of a preferred embodiment of an infrared spectrometer in accordance with the present invention.

### DESCRIPTION OF THE PREFERRED EMBODIMENT

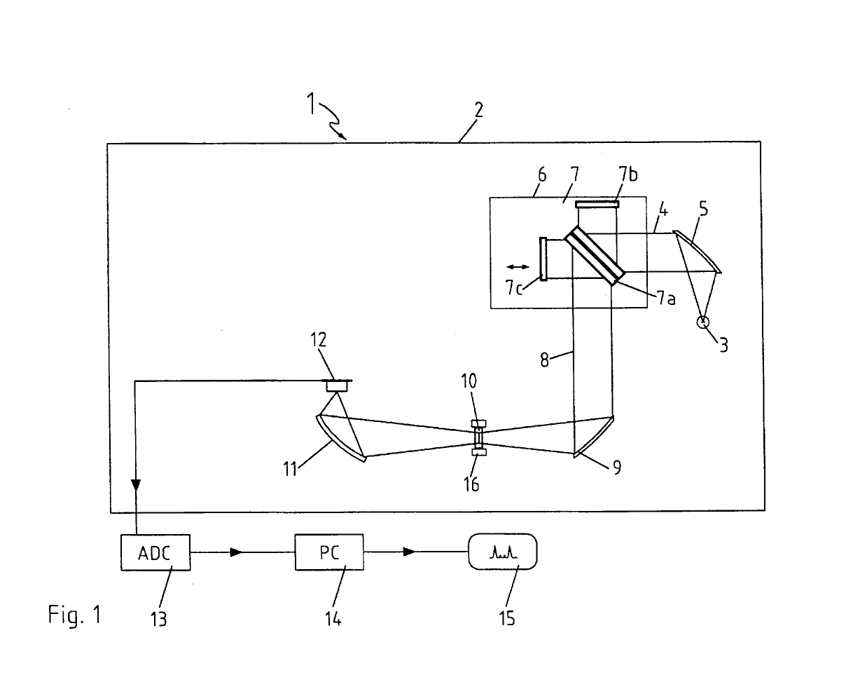

In detail, FIG. 1 shows a schematic view of an FTIR spectrometer 1 with a housing 2. A light source 3 is integrated into the housing 2. The source 3 emits an input light beam 4, via a concave mirror 5, to a Michelson interferometer 7 located in an interferometer compartment 6. The interferometer 7 consists of a beamsplitter 7a and two interferometer mirrors 7b, 7c or retroreflectors, one of which is movable. A collimated output light beam 8 leaves the interferometer 7 and the interferometer compartment 6. At a sample position on a sample holder 16 a transparent sample 10 is irradiated by the output light beam 8 by means of a focusing concave mirror 9. Another concave mirror 11 concentrates the light passing the sample 10 onto the detector 12. No image of the sample appears on the detector surface. The analogue detector 12 signal is directed to a digitizing unit 13 where it is digitized. A PC 14 monitors or controls the mirror translation of the interferometer 7, the data acquisition performed by the detector 12 and the digitizing unit 13, and processes the digitized signals to an optical spectrum, displayed by a CRT 15.

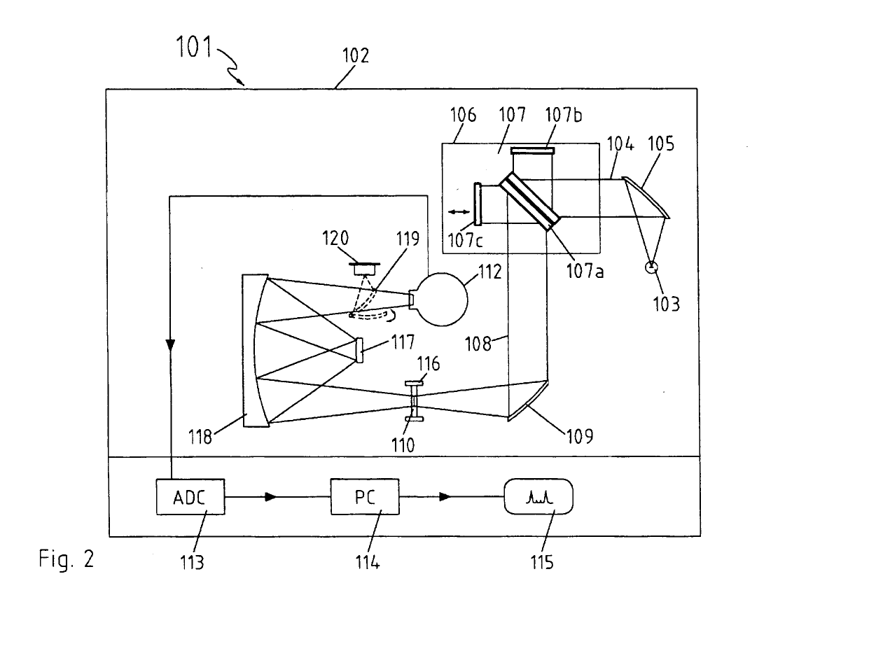

FIG. 2 shows a schematic view of an FTIR spectrometer 101 with a housing 102. A light source 103 is integrated into the housing 102. The source 103 emits an input light beam 104, via a concave mirror 105, to a Michelson interferometer 107 located in an interferometer compartment 106. The interferometer 107 consists of a beamsplitter 107a and two interferometer mirrors 107b, 107c or retroreflectors, one of which is movable. A collimated output light beam 108 leaves the interferometer 107 and the interferometer compartment 106. The sample 110 is homogeneously irradiated by means of an imaging concave mirror 109. The light passing the sample is imaged via an optical system consisting of a concave 118 and convex 117 mirror system on the surface of the FPA detector array 112. The analogue signals of the detector array 112 are directed to a digitizing unit 113 where they are digitized. A PC 114 monitors or controls the mirror translation of the interferometer 107, the data acquisition performed by the FPA array 112 and the digitizing unit 113, and processes the digitized signals to a spatially resolved optical spectrum that is resolved across the surface of the FPA array . The spectrum is displayed by a CRT 115.

Alternatively, the light coming from the sample surface can also be directed to a basic, non-imaging detector 120 by means of the hinged mirror 119.

Obviously, the imaging components can also consist of lenses or a combination of mirrors and lenses.

An especially preferred embodiment of the present invention uses digitizing units (12; 113) which are not separate but integrated into the FPA detector (12; 112). This means, that a group of pixels or each pixel of the detector array on the detector chip is assigned to an individual ADC (analogue-to-digital converter), preferably integrated into the FPA detector, so that the chip itself is able to emanate digitized signals. As already mentioned hereinbefore especially this embodiment can also be used independently, i.e. in connection with otherwise prior-art imaging IR spectrometers.

1. An infrared spectrometer comprising:
a housing;
an optical light source;
an interferometer disposed within said housing to divide input light emitted by said light source into two partial beams for generating a variable optical path length difference between said two partial beams and to recombine said two partial beams into one output light beam;
means for positioning and accepting a sample in or on said housing, said output light beam being incident on the sample;
an imaging, two dimensional detector array for accepting and analyzing a detector light beam emanating from the sample;
imaging optics disposed for imaging a sample surface, using said detector light beam emanating from the sample, onto said imaging, two dimensional detector array; and
means communicating with an output of said detector to process sample signals.

2. The infrared spectrometer of claim 1, wherein said light source is one of integrated in said housing and flanged to said housing.

3. The infrared spectrometer of claim 1, wherein said detector is one of integrated in said housing and flanged to said housing.

4. The infrared spectrometer of claim 2, wherein said detector is one of integrated in said housing and flanged to said housing.

5. The infrared spectrometer of claim 1, wherein said sample positioning means is integrated in said housing.

6. The infrared spectrometer of claim 2, wherein said sample positioning means is integrated in said housing.

7. The infrared spectrometer of claim 3, wherein said sample positioning means is integrated in said housing.

8. The infrared spectrometer of claim 1, further comprising a conventional detector, said conventional detector being mutually exchangeable with said imaging, two dimensional detector array.

9. The infrared spectrometer of claim 2, further comprising a conventional detector, said conventional detector being mutually exchangeable with said imaging, two dimensional detector array.

10. The infrared spectrometer of claim 3, further comprising a conventional detector, said conventional detector being mutually exchangeable with said imaging, two dimensional detector array.

11. The infrared spectrometer of claim 5, further comprising a conventional detector, said conventional detector being mutually exchangeable with said imaging, two dimensional detector array.

12. The infrared spectrometer of claim 1, further comprising a conventional, non-imaging detector and means for switching said detector light beam between said non-imaging detector and said imaging detector.

13. The infrared spectrometer of claim 2, further comprising a conventional, non-imaging detector and means for switching said detector light beam between said non-imaging detector and said imaging detector.

14. The infrared spectrometer of claim 3, further comprising a conventional, non-imaging detector and means for switching said detector light beam between said non-imaging detector and said imaging detector.

15. The infrared spectrometer of claim 12, wherein said switching means comprises a hinged mirror.

16. The infrared spectrometer of claim 1, wherein said imaging detector and said processing means enable a signal of each pixel or of a group of pixels to be dedicated to a separate digitizing procedure.

17. The infrared spectrometer of claim 2, wherein said imaging detector and said processing means enable a signal of each pixel or of a group of pixels to be dedicated to a separate digitizing procedure.

18. The infrared spectrometer of claim 3, wherein said imaging detector and said processing means enable a signal of each pixel or of a group of pixels to be dedicated to a separate digitizing procedure.

19. The infrared spectrometer of claim 5, wherein said imaging detector and said processing means enable a signal of each pixel or of a group of pixels to be dedicated to a separate digitizing procedure.

20. The infrared spectrometer of claim 16, wherein said signal processing means is integrated into said imaging detector such that each pixel is dedicated to an individual ADC on an array chip.
